(19) United States
(12) Patent Application Publication
(10) Pub. No.: US 2006/0156718 A1
(43) Pub. Date: Jul. 20, 2006

(54) Buoyancy Motor

(76) Inventor: Tony Petkovic, Vancouver (CA)

Correspondence Address: Mr. Tony Petkovic, 3045 West 5th Avenue, Vancouver, V6K1T8, CA

(21) Appl. No.: 10/905,777

(22) Filed: Jan. 20, 2005

(51) Int. Cl. F03B 17/02

(52) U.S. Cl. 60/496; 60/495

(57) ABSTRACT

The frame structure contains a main shaft, which turns a rotor hence turning four main bearings by using the force of buoyancy. On the lower section of the frame there is a ball-limiting guide, which is located on the right side of the main shaft. The distance is far enough away so that airtight balls can rotate freely. When the ball positions are located on the longest positions of the arms, away from ball positions on the shortest positions of the arms buoyancy forces ball positions towards Bottom Dead Centre (BDC). At this time a circular motion is created around the main shaft thus increasing power from buoyancy.

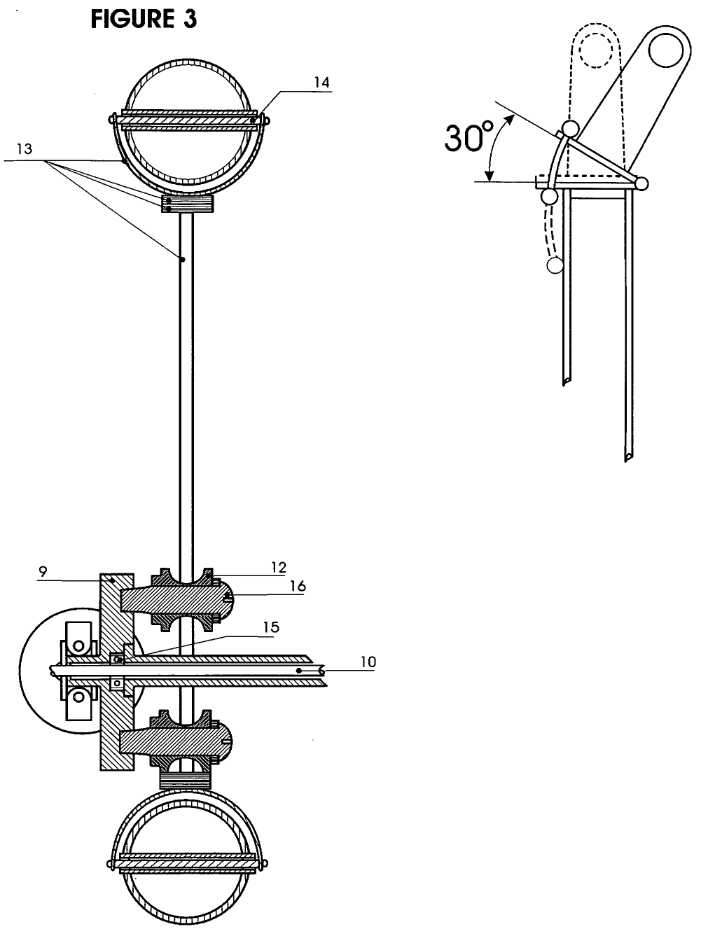

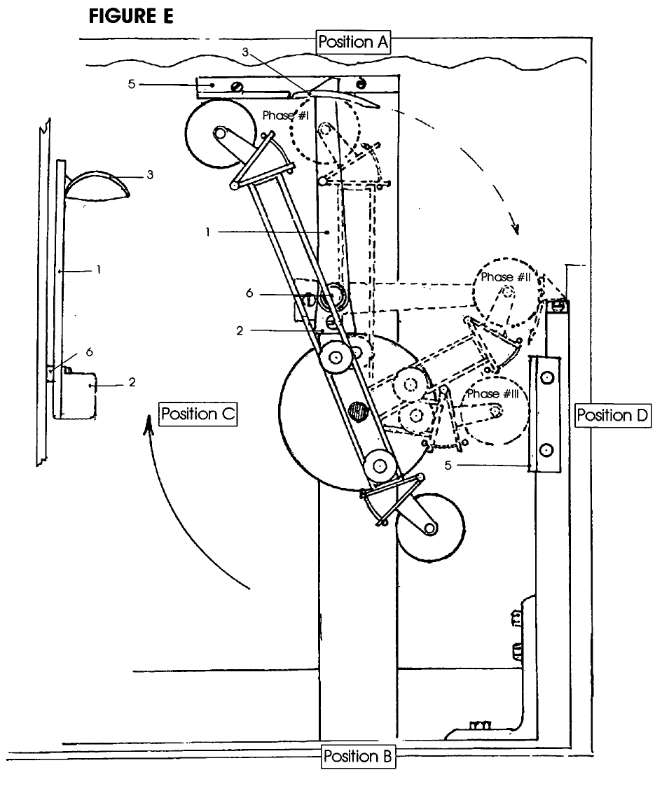

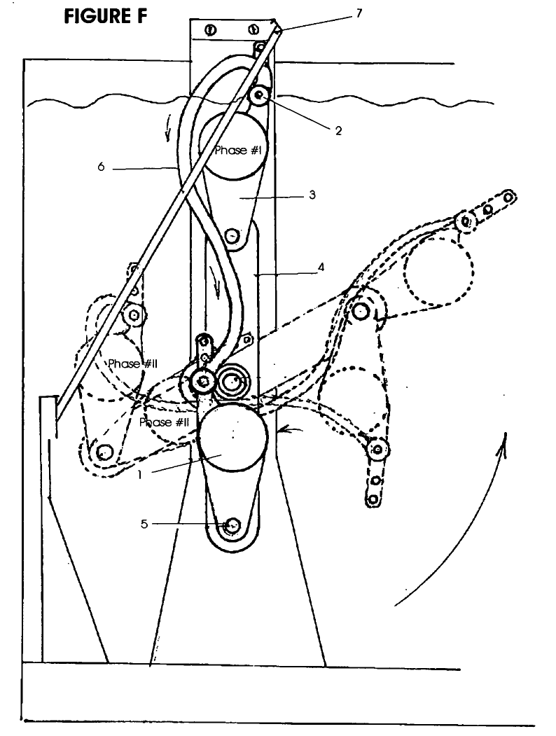

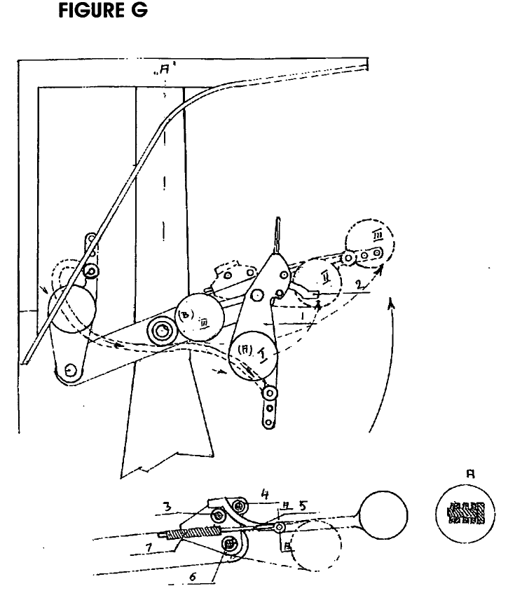

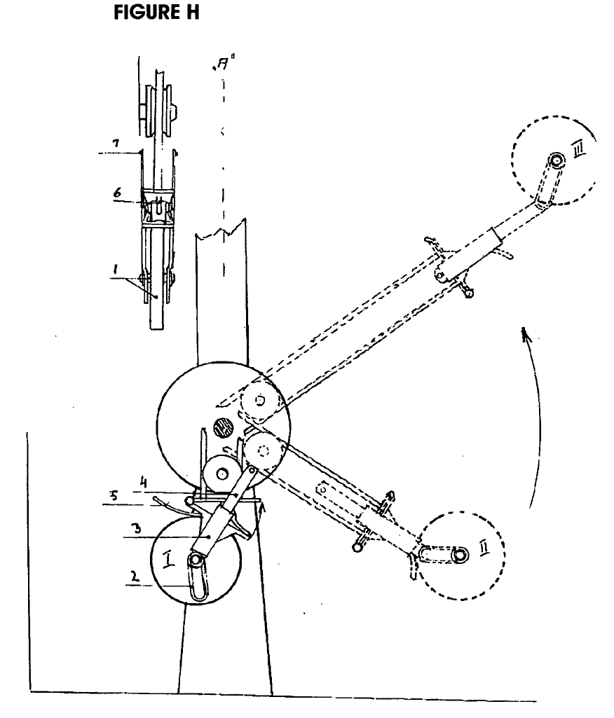

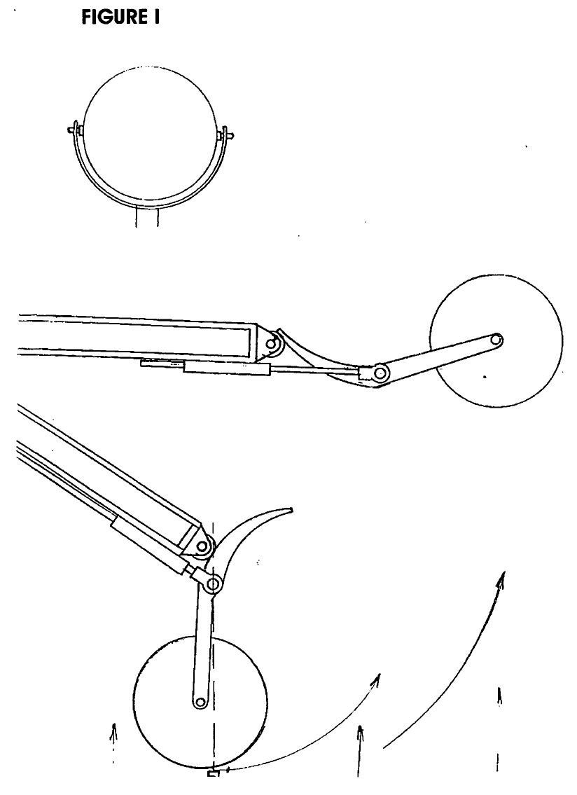

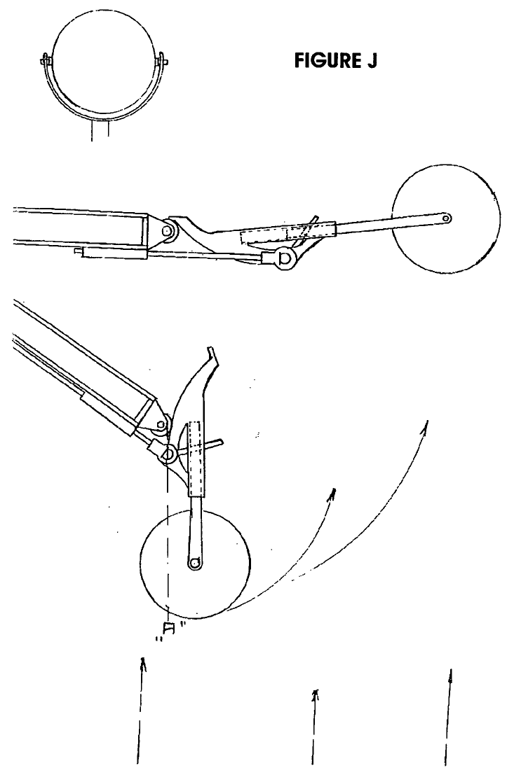

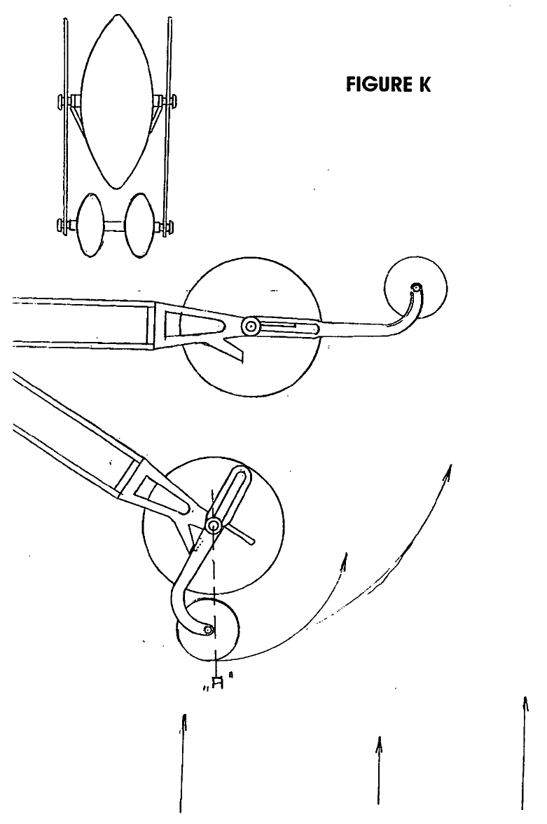

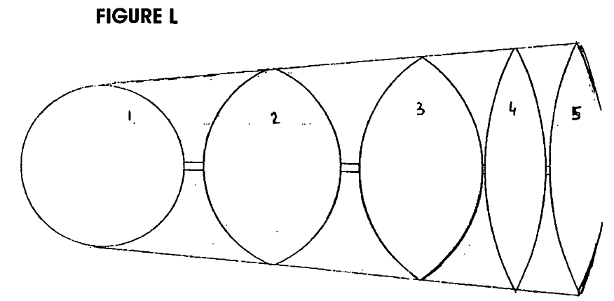

A motor that generates power from buoyancy.
1. The machine's primary source of power is obtained from the force of buoyancy in order for it to work.
2. Part #21 is located on a partially submerged water tank.
3. The force of buoyancy in a rotating motion will push airtight balls upwards (#1, #2, #3, #4, #5, #6, #7 and #8).
4. Part #20 (frame structure), holds the entire assembly.
5. Part #10 (main shaft), holds #9 (rotor) in place.
6. Part #15 (main bearing) and #16 (bearing shaft) are part of the rotor assembly.
7. Part #12 (roller guide), is connected to #9 (rotor).
8. Part #13 (sliding ball carrier), slides freely over #12 (roller guide).
9. Part #13 has a built in shaft (#14), which airtight balls rotate and can open to a 30° angle (see FIG. 3).
10. Part #20 (frame structure), on the left side, there is a ball-limiting guide (#11), which is located far enough away from #10 (main shaft) so that the ball can rotate freely.
11. On top of Part #20 (frame structure), point “A”, is Top Dead Centre (TDC). Opposite to “A” is “B”, Bottom Dead Centre (BDC).
12. In the horizontal position on the right side of #10 (main shaft) is “C”, the longest length of the arm. On the left side it shows the shortest extent of the arm (“D”).
13. Balls #4, #6 and #8 are located on the longer side of the arm away from balls #1, #2, #3, #5 and #7. Buoyancy forces balls #4, #6 and #8 to rotate upwards to point “A” (TDC). A circular motion begins around the main shaft (#10).
14. When ball #1 passes point “A” the force of buoyancy opens the ball travel by 30°, which allows for easier ball travel on #11 (ball-limiting guide) while making contact as it turns around the shaft (#14).
15. At the same time ball #2 passes point “B” and the force of buoyancy returns it back to its normal position. The process is the same for all balls going through this circular motion.
16. Due to the fact that #11 (ball-limiting guide) is positioned in such a way that balls #1, #2 and #3 while turning, shorten the distance of the arm point. This enlarges the length to the opposite side point “C”. Enlarging the length of #11 (ball-limiting guide), which is built on #13 (sliding ball carrier) provides the power source for the motor to work efficiently.

The Buoyancy Motor is made up of the following parts:

Part 1-8 Airtight Balls

Part 9 Rotor

Part 10 Main Shaft

Part 11 Ball-Limiting Guide

Part 12 Roller Guide

Part 13 Sliding Ball Carrier

Part 14 Shaft

Part 15 Main Bearing

Part 16 Bearing Shaft

Part 19 and 20 Pulley and Frame Structure

“A” Top Dead Centre (TDC)

“B” Bottom Dead Centre (BDC)

“C” Lever Arm (Longer)

“D” Lever Arm (Shorter)

### INCREASING THE FORCE

The buoyancy motor works on the principle of increasing and decreasing the length of the arm in order to obtain a larger force. There are five ways as shown in Figures G, H, J, K, and I.

Figure G

On the ball carrier (#1) there is a built-in stationary ball (A), which has two roller shafts. (#3) and (#4). Between the two roller shafts travels offset arm (#2) with a secured ball on its end (B). (#5) is a sliding stabilizer, which travels between the shaft. During the rotation (#1), when it reaches 90°, buoyancy force pushes upward (#1) and the ball (A) shuts the 180° angle. At this time ball (B) rotates past 90° and buoyancy force pushes it up and the mechanism enlarges the length of the arm (Phase #3).

Figure H shows a second way of increasing the arm. This mechanism is made in such a way that it uses an angle of 30°.

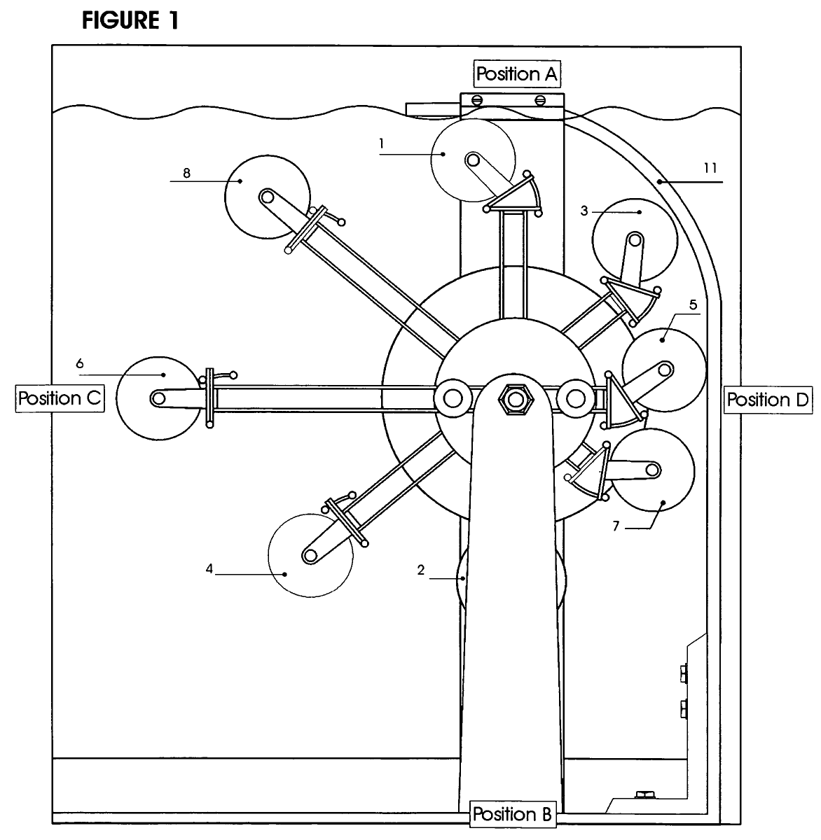

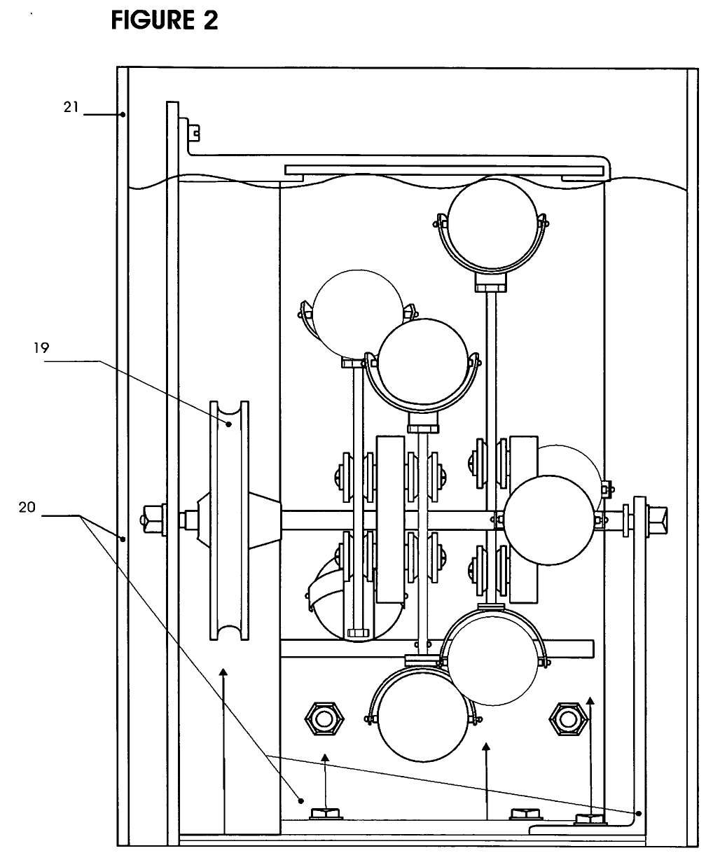

When the ball passes 90° the buoyancy force pushes upward decreasing the 30° angle and creates pressure (#5) by turning on the shaft (#6). The larger end of the arm (#5) forces the ball into Phase #1. As it freely moves (FIG. 2) it goes into Phase #2. Ball rotates further and moves to upper end (#2) and arm enlarges (FIG. 2) and goes into Phase #2. Further rotation of the ball goes to upper end (#2). The arm enlarges the angle of 90° towards position (A). Buoyancy force is always pushing upward. The mechanism (#4) slides through (#3). Diagram or position of rotation (#4) shows position (#2) and (#1). It all stops on FIG. 1, Phase #3 and the arm is longer which allows for a larger force of power. How the arm is made longer, which works on the buoyancy force, is shown in Figures I through K.

Reduction in Fluid Resistance

Buoyancy motor uses natural forces present in fluid to develop its rotation and turn it into energy. During its rotation there is fluid resistance.

Figures E, F, and L show a way to lower this fluid resistance.

Figure E

In the construction of the motor there is an additional arm (#1) installed, which rotates freely on the shaft (#6). It is balanced (#2), and the other end of the arm there is a ball receiver with a counter weight (#3). This arm receives the ball and travels towards point “D”. Before the arm comes to point “D” it (#4) stops it on the border and at that time the ball travels to position (#5). Because of buoyancy the arm is forced, which is in the position (#1) returns up and waits for the ball, which is passing Point “A”. From Phase #1 the ball goes to Phase #2 and Phase #4, which is on the point “D” of the shorter end of the arm. Because of buoyancy the ball is forced on the opposite side of the arm and goes up and a rotation is developed around position (#10). By installing this arm (#1) fluid resistance is decreased by approximately 25%.

Figure F

The main carrier of the balls (#4), turns on its centre point. The main carrier (#4) has shafts on the ends (#5) located at (#3). The carrier has a built in ball (#1).

The ball carrier (#3) has enlarged holes, which serve to lower the fluid resistance over the connecting rod (#6). At this time connecting rod (#6) goes over the hole, which is away from the centre (#5) and the fluid resistance is decreased on the bottom of the connecting rod. A built-in roller (#2), rotates on ball-limiting guide (#7). At the same time on its way to Phase # 1 it shortens the arm. At phase #2 and #3 buoyancy pushes the ball on the opposite side upwards and enlarges the length of the arm, which enables the rotation around shaft (#8). Figure H shows how to change the shape of the ball and lower the fluid resistance.

What is claimed is:

1. Power is generated from water buoyancy.

2. Extendable arms increase torque and power.

3. Depressed balls decrease resistance.
